(19) United States
(12) Patent Application Publication
(10) Pub. No.: US 2021/0097957 A1
(43) Pub. Date: Apr. 1, 2021

(54) ELECTRONIC APPARATUS AND CONTROLLING METHOD

(71) Applicant: LENOVO (SINGAPORE) PTE. LTD., Singapore (SG)

(72) Inventors: Moriyuki Tsuchihashi, YOKOHAMA (JP); Hidetoshi Mori, YOKOHAMA (JP); Limin Xiao, YOKOHAMA (JP)

(73) Assignee: LENOVO (SINGAPORE) PTE. LTD., SINGAPORE (SG)

(21) Appl. No.: 16/742,826

(22) Filed: Jan. 14, 2020

(30) Foreign Application Priority Data
Sep. 26, 2019 (JP) 2019175661

(51) Int. Cl. G09G 5/10; G09G 5/12

(52) U.S. Cl. CPC G09G 5/10; G09G 5/12; G09G 2320/0686; G09G 2320/0626; G09G 2354/00

(57) ABSTRACT

An electronic apparatus includes a first luminance adjustment section which performs luminance adjustment of a first display unit and luminance adjustment of a second display unit in linkage with each other in accordance with a first operation and a second luminance adjustment section which performs only the luminance adjustment of the second display unit in accordance with a second operation.

### FIELD OF THE INVENTION

The present invention relates to an electronic apparatus and a controlling method.

### BACKGROUND OF THE INVENTION

In an electronic apparatus such as a Laptop PC and so forth, it is possible to adjust a luminance of a display unit (for example, Japanese Unexamined Patent Application Publication No. 2009-217775). For example, a user adjusts the luminance of the display unit so as to visually recognize an image on the display unit with ease by increasing the luminance in a bright environment and decreasing the luminance in a dark environment depending on environmental changes such as an indoor environment, an outdoor environment and so forth.

### SUMMARY OF THE INVENTION

Incidentally, in the electronic apparatuses of the above-mentioned type, there also exists an electronic apparatus which includes a sub display unit in addition to a main display unit. In the electronic apparatuses of the type of including a plurality (for example, two) display units in this way, there also exists an electronic apparatus that although adjustment of a luminance of one display unit (for example, the main display unit) is possible, adjustment of a luminance of the other display unit (for example, the sub display unit) is impossible. However, the respective display units are different from each other in effect extent of environments depending on a difference in position where each display unit is installed on the electronic apparatus and so forth and therefore there are cases where it is desirable to adjust the luminances of the respective display units separately. On the other hand, in a case where a change occurs in the environment, there are also cases where it is desirable to increase or decrease the luminances of the both display units.

The present invention has been made in view of the above-mentioned circumstances and aims to provide an electronic apparatus and a controlling method which make it possible to appropriately adjust the luminances of the plurality of display units by a simple operation.

The present invention has been made in order to solve the above-mentioned problem. An electronic apparatus according to the first aspect of the present invention includes a first luminance adjustment section which is configured to perform luminance adjustment of a first display unit and luminance adjustment of a second display unit in linkage with each other in accordance with a first operation and a second luminance adjustment section which is configured to perform only the luminance adjustment of the second display unit in accordance with a second operation.

In the above-described electronic apparatus, the first luminance adjustment section may perform the luminance adjustment of the first display unit and the luminance adjustment of the second display unit in linkage with each other in accordance with the first operation in such a manner that a relation between a luminance of the first display unit and a luminance of the second display unit is maintained.

The above-described electronic apparatus may further include a first setting section which is configured to set at least one of a first adjustment value which becomes a maximum luminance and a second adjustment value which becomes a minimum luminance in a range of the luminance adjustment of the first display unit on the basis of a user operation, and a second setting section which is configured to set at least one of a third adjustment value which becomes a maximum luminance and a fourth adjustment value which becomes a minimum luminance in a range of the luminance adjustment of the second display unit on the basis of a user operation, in which the first luminance adjustment section may adjust the luminance of the first display unit so as to be changed between the first adjustment value and the second adjustment value and may adjust the luminance of the second display unit so as to be changed between the third adjustment value and the fourth adjustment value, and the second luminance adjustment section may adjust the luminance of the second display unit so as to be changed between the third adjustment value and the fourth adjustment value.

In the above-described electronic apparatus accordingly, the first setting section may set a fifth adjustment value which becomes a predetermined luminance between the first adjustment value and the second adjustment value on the basis of a user operation, the second setting section may set a sixth adjustment value which becomes a predetermined luminance between the third adjustment value and the fourth adjustment value on the basis of a user operation, the first luminance adjustment section may adjust the luminance of the first display unit so as to be changed by passing the fifth adjustment value in a case of adjusting the luminance of the first display unit between the first adjustment value and the second adjustment value and may adjust the luminance of the second display unit so as to be changed by passing the sixth adjustment value in a case of adjusting the luminance of the second display unit between the third adjustment value and the fourth adjustment value, and the second luminance adjustment section may adjust the luminance of the second display unit so as to be changed by passing the sixth adjustment value in a case of adjusting the luminance of the second display unit between the third adjustment value and the fourth adjustment value.

In the above-described electronic apparatus, the second display unit may be smaller than the first display unit in area of a display screen.

The above-described electronic apparatus may further include a first main body which is configured to install thereon an input unit into which a user operation is input and a second main body which is configured to be coupled to the first main body to be rotationally movable relative to the first main body, in which the first display unit may be installed on the second main body, the second display unit may be installed on a face side of the first main body which is the same as the face side on which the input unit is installed, and the second display unit may be set higher than the first display unit in maximum value of a front luminance.

In addition, a controlling method for an electronic apparatus according to the second aspect of the present invention includes the steps of performing luminance adjustment of a first display unit and luminance adjustment of a second display unit in linkage with each other in accordance with a first operation by using a first luminance adjustment section and performing only the luminance adjustment of the second display unit in accordance with a second operation by using a second luminance adjustment section.

In addition, an electronic apparatus according to the third aspect of the present invention includes a first display unit, a second display unit, a first GPU (Graphic Processing unit) which is configured to control a luminance of the first display unit and a second GPU which is configured to control a luminance of the second display unit.

In the above-described electronic apparatus, the second GPU may control the luminance of the second display unit so as to become higher than the luminance of the first display unit in a state where the first display unit and the second display unit are arranged facing different directions.

In the above-described electronic apparatus, a ratio of the luminance of the first display unit to the luminance of the second display unit may be defined in accordance with an angle between a direction that the first display unit is oriented and a direction that the second display unit is oriented.

In the above-described electronic apparatus, the first GPU may be a CPU built-in type GPU which is integrated into a CPU (Central Processing Unit).

### Advantageous Effects of the Present Invention

The above-described aspects of the present invention can appropriately adjust the luminances of the plurality of display units by the simple operation.

### BRIEF DESCRIPTION OF THE DRAWINGS

FIG. 1 is an explanatory diagram illustrating one example of an outline of an electronic apparatus according to a first embodiment of the present invention.

FIG. 2A is a sectional diagram illustrating one example of a state where the electronic apparatus according to the first embodiment is viewed from a side face.

FIG. 2B is a sectional diagram illustrating one example of the state where the electronic apparatus according to the first embodiment is viewed from the side face.

FIG. 2C is a sectional diagram illustrating one example of the state where the electronic apparatus according to the first embodiment is viewed from the side face.

FIG. 3A is a diagram illustrating one example of an outline of adjustment of luminances of display units according to the first embodiment.

FIG. 3B is a diagram illustrating one example of the outline of adjustment of the luminances of the display units according to the first embodiment.

FIG. 4 is a schematic block diagram illustrating one configuration example of the electronic apparatus according to the first embodiment.

FIG. 5 is a block diagram illustrating one functional configuration example relating to luminance adjustment control according to the first embodiment.

FIG. 6 is a diagram illustrating one example of luminance adjustment according to the first embodiment.

FIG. 7 is a flowchart illustrating one example of luminance adjustment processing according to the first embodiment.

FIG. 8 is a block diagram illustrating one functional configuration example relating to luminance adjustment control according to a second embodiment.

FIG. 9 is a diagram illustrating one example of luminance adjustment according to the second embodiment.

FIG. 10 is a diagram illustrating one example of a change in luminance by the luminance adjustment which is illustrated in FIG. 9 in the form of a graph.

FIG. 11 is a diagram illustrating one example of a change in luminance by luminance adjustment which is obtained in a case of changing a current luminance adjustment value in the form of a graph.

### DETAILED DESCRIPTION OF THE INVENTION

In the following, embodiments of the present invention will be described with reference to the drawings.

### First Embodiment

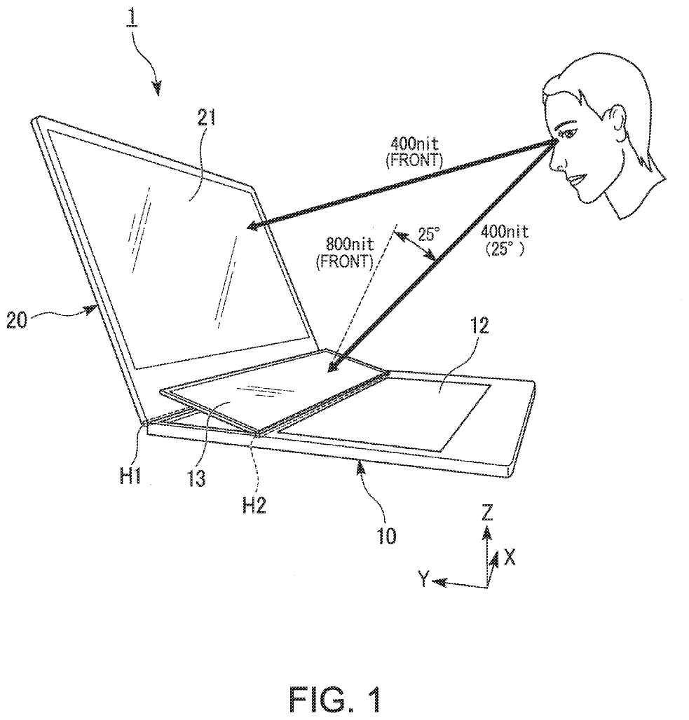

First, an outline of an electronic apparatus according to the first embodiment of the present invention will be described with reference to FIG. 1. FIG. 1 is an explanatory diagram illustrating one example of an outline of an electronic apparatus 1 according to the first embodiment of the present invention. The electronic apparatus 1 according to the first embodiment is an information processing apparatus such as, for example, a clamshell-shaped (Laptop) PC (Personal Computer) and so forth.

Here, in the first embodiment, a positional relation between/among respective configurations will be described by setting a rectangular Cartesian coordinate system of X, Y and Z axes. In the following, a direction which is oriented along the X axis (an X-axis direction) will be referred to as a left-right direction, a direction which is oriented along the Y axis (a Y-axis direction) will be referred to as a front-back direction, and a direction which is oriented along the Z axis (a Z-axis direction) will be referred to as a top-bottom direction. In the top-bottom direction, the side that a first main body 10 is located will be referred to as “bottom” and the side that a second main body 20 is located will be referred to as “top”. In the front-back direction, the side which is closer to a first hinge H1 will be referred to as “rear” and the side which is opposite thereto will be referred to as “front”.

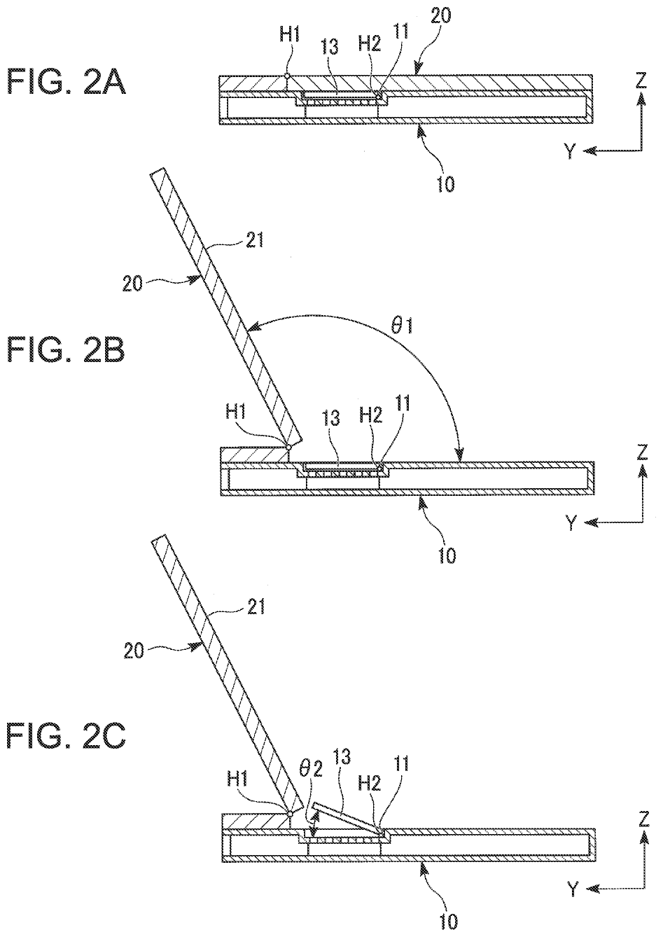

The first main body 10 and the second main body 20 are coupled together via the first hinge H1 to be rotationally movable relatively. The first main body 10 and the second main body 20 are configured to be rotationally movable relatively about the first hinge H1 between a closed state and an opened state. Here, the closed state is a state where the second main body 20 rotationally moves so as to hang over the first main body 10 and then the first main body 10 and the second main body 20 are placed one on top of another. The opened state is a state where the second main body 20 is opened by rotationally moving away from the first main body 10 and an opening angle θ1 (see FIG. 2B) between the first main body 10 and the second main body 20 exceeds a predetermined angle.

A main display 21 which serves as a main display unit of the electronic apparatus 1 is installed on the second main body 20. The main display 21 is installed on the face side of the second main body 20 which is opposite to an upper face of the first main body 10 in the closed state. The main display 21 is configured by including, for example, a liquid crystal display (LCD). Incidentally, the main display 21 may be configured by including an organic EL (Electro Luminescence) display and so forth, not limited to the liquid crystal display.

An input unit 12 and a sub display 13 are installed on the first main body 10. The input unit 12 is a keyboard, a touch pad, a touch sensor and so forth. The sub display 13 is smaller than the main display 21 in area of a display screen and has a rectangular shape which is long in the left-right direction and is short in the front-back direction. The sub display 13 is installed between the input unit 12 and the first hinge H1 on the face side of the first main body 10 that the input unit 12 is installed. In a case where the second main body 20 is closed relative to the first main body 10 (is closed and is placed on the first main body 10), the sub display 13 confronts the main display 21 on the second main body 20 in the top-bottom direction. The sub display 13 is configured by including, for example, a liquid crystal display. Incidentally, the sub display 13 may be configured by including an organic EL (Electro Luminescence) display and so forth, not limited to the liquid crystal display. In addition, a mother board (a substrate) on which electronic components are loaded, a battery and so forth are installed in the first main body 10. Incidentally, although in the example illustrated in FIG. 1, the first main body 10 is coupled to the second main body 20 to be rotationally movable via the first hinge H1, the first main body 10 and the second main body 20 may be also configured to be separable.

The first hinge H1 which couples together the first main body 10 and the second main body 20 extends along the left-right direction. When the electronic apparatus 1 is brought from the closed state into the opened state, the second main body 20 rotationally moves upward about the first hinge H1. In a case where the electronic apparatus 1 is brought into the opened state, the main display 21 which is installed on the second main body 20 is exposed forward and the upper face of the first main body 10 is opened and thereby the input unit 12 and the sub display 13 are brought into upward exposed states. The electronic apparatus 1 which is illustrated in FIG. 1 exhibits a situation of being maintained in the opened state that a user generally uses the electronic apparatus 1. This situation is an example of a state where the opening angle θ1 (see FIG. 2B) between the first main body 10 and the second main body 20 is maintained in a range of about 100°≤θ1≤130°.

In addition, the sub display 13 is configured to be rotationally movable about a second hinge H2 and it is possible to stand the sub display 13 diagonally with an angle being made relative to the upper face of the first main body 10 in the opened state. FIG. 2A, FIG. 2B and FIG. 2C are sectional diagrams illustrating one example of a state where the electronic apparatus 1 is viewed from a side face. A housing section 11 is formed in the first main body 10. The housing section 11 is a recessed portion which is depressed downward from the upper face of the first main body 10. The housing section 11 is larger than the sub display 13 and is formed into a rectangular shape which is longer in the left-right direction than in the front-back direction when viewing from the top-bottom direction so as to make it possible to house the sub display 13 therein.

In the closed state (see FIG. 2A), the sub display 13 is housed in the housing section 11. The second hinge H2 is installed in the housing section 11 and extends along the left-right direction (the X-axis direction). The sub display 13 is in a state of being rotationally movable about the second hinge H2 and, in a case of bringing the second main body 20 into the opened state (see FIG. 2B), it becomes possible to open (to stand the sub display 13 diagonally) the sub display 13 relative to the upper face of the first main body 10 (see FIG. 2C).

The sub display 13 is configured to rotationally move about the second hinge H2 manually. In this case, it is possible to preferably use a torque hinge and so forth which are capable of holding the sub display 13 at a predetermined angle as the second hinge H2. Otherwise, the sub display 13 may be brought into an upward urged state by using an urging member such as a spring and so forth, and in a case where the second main body 20 is closed, the second main body 20 may bring the sub display 13 into a downward depressed state. In this case, when the second main body 20 is opened, it becomes possible to automatically stand the sub display 13 in linkage with the second main body 20. An angle θ2 (see FIG. 2C) at which the sub display 13 is rotationally movable about the second hinge H2 is set in a range of, for example, 2°≤θ2≤40°.

As illustrated in FIG. 1, the electronic apparatus 1 is configured to make it possible for the user to visually confirm both the main display 21 and the sub display 13 in the opened state. The user opens the second main body 20 relative to the first main body 10 so as to obtain an angle at which it becomes easy for the user to visually confirm the main display 21. In this case, in general, the user opens the second main body 20 to the opening angle θ1 at which a state where front viewing of the main display 21 becomes almost possible is obtained. On the other hand, since the sub display 13 is installed on the upper face of the first main body 10, the user visually confirms the sub display 13 from a direction which is shifted from the front to a certain extent consequently. In the illustrated examples, the sub display 13 is rotationally moved relative to the first main body 10 through the angle θ2 (see FIG. 2C) and then diagonally stands. Therefore, although a display face of the sub display 13 is directed toward a direction that the user sees the sub display 13 better than in a state where the sub display 13 lies on the upper face of the first main body 10, the user's eye gaze is still in a state of shifting from the front.

Although user's eye gaze directions relative to the main display 21 and the sub display 13 change depending on the opening angle θ1 between the first main body 10 and the second main body 20, the standing angle θ2 of the sub display 13, a user's head position and so forth, here, it is supposed that the opening angle θ1 of the main display 21 relative to the second main body 20 is about 115°, the standing angle θ2 at which the sub display 13 stands relative to the first main body 10 is about 40° and the direction that the user's eye gaze is turned to the main display 21 is a front direction of the main display 21 as a typical use example of the electronic apparatus 1. In this case, the direction that the user who views the main display 21 from the front turns his/her eye gaze to the sub display 13 is a direction which is shifted from the front of the sub display 13 by about 25° (see FIG. 1).

A maximum value of a front-direction luminance (hereinafter, referred to as a “front luminance”) of the main display 21 is set to become, for example, 400 nit. On the other hand, a maximum value of a front luminance of the sub display 13 is set to become a value (for example, 800 nit) which is higher than the maximum value of the front luminance of the main display 21. The maximum luminance values of the main display 21 and the sub display 13 are set in this way for the purpose of making a maximum value of a luminance of light which travels in a direction which is shifted from the front of the sub display 13 by 25° (hereinafter, referred to as a “25-degree luminance”) equal (for example, 400 nit) to the maximum value of the front luminance of the main display 21 from the fact that the luminance is decreased as the user's eye-gaze direction is shifted from the front direction of the sub display 13. The electronic apparatus 1 controls so as to make the luminance of the sub display 13 higher than the luminance of the main display 21 in a state where the sub display 13 and the main display 21 are arranged facing mutually different directions in this way. In addition, the ratio of the luminance of the sub display 13 to the luminance of the main display 21 is defined in accordance with an angle between a direction that the sub display 13 is oriented and a direction that the main display 21 is oriented.

Incidentally, in the following, basically, description will be made on condition that the luminance of the main display 21 is the front luminance and the luminance of the sub display 13 is the 25-degree luminance. That is, the description will be made on condition that both the main display 21 and the sub display 13 have the same maximum value (for example 400 nit) in the user's eye-gaze direction.

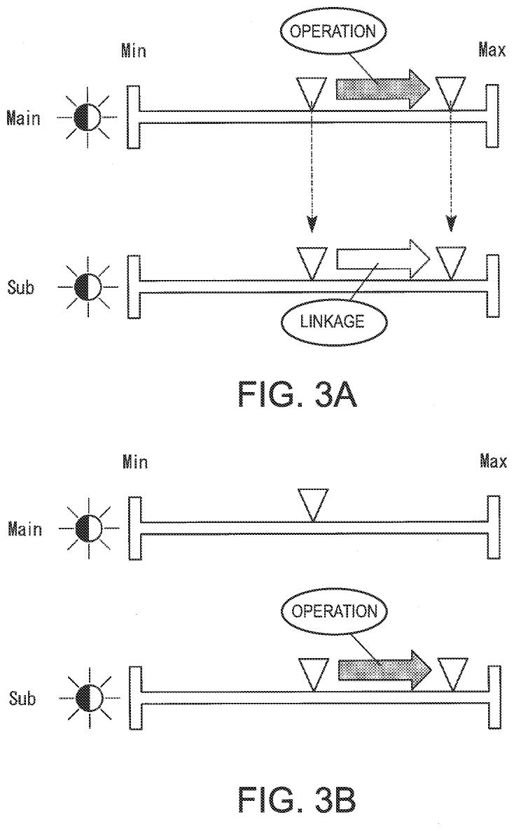

Next, an outline of luminance adjustment of the main display 21 and the sub display 13 will be described. FIG. 3 (FIG. 3A and FIG. 3B) is a diagram illustrating one example of the outline of the luminance adjustment of display units (the main display 21 and the sub display 13) according to the first embodiment. FIG. 3 illustrates one example of operation UIs (User Interface(s)) which perform luminance adjustment of the main display 21 and the sub display 13. The operation UI is displayed on, for example, the main display 21 in accordance with a predetermined operation. The upper-stage UI is the operation UI which accepts an operation for the luminance adjustment of the main display 21 and the lower-stage UI is the operation UI which accepts an operation for the luminance adjustment of the sub display 13. In the respective operation UIs, it is possible to adjust the luminance ranging from a minimum luminance (for example, 0 nit) to a maximum luminance (for example, 400 nit) by sliding an inverted-triangle mark which indicates a current adjustment value in the left-right direction between a left end (Min) at which the luminance becomes the minimum value and a right end (Max) at which the luminance becomes the maximum value.

FIG. 3A illustrate one example of movement of the adjustment value in a case where the user operates the operation UI which accepts the operation for the luminance adjustment of the main display 21. In a case where an operation of sliding the upper-stage inverted-triangle mark which indicates the current adjustment value of the main display 21 is performed, the luminance adjustment value of the main display 21 is changed in accordance with the position of the inverted-triangle mark and also the luminance adjustment value (the position of the lower-stage inverted-triangle mark) of the sub display 13 is changed in linkage with changing of the luminance adjustment value of the main display 21. That is, the luminance adjustment of the main display 21 and the luminance adjustment of the sub display 13 are performed in linkage (i.e., in conjunction) with each other in accordance with the operation of performing the luminance adjustment of the main display 21.

On the other hand, FIG. 3B illustrates one example of movement of the adjustment value in a case where the user operates the operation UI which accepts the operation for the luminance adjustment of the sub display 13. In a case where an operation of sliding the lower-stage inverted-triangle mark which indicates the current adjustment value of the sub display 13 is performed, the luminance adjustment value of the sub display 13 is changed in accordance with the position of the inverted-triangle mark. The luminance adjustment value of the main display 21 is not changed.

According to the first embodiment, in a case where the luminance of the main display 21 is adjusted, also the luminance of the sub display 13 is adjusted in linkage with the luminance adjustment of the main display 21 in this way. Therefore, for example, in a case of wishing to increase or decrease the luminances of both the main display 21 and the sub display 13, it is not necessary to adjust the luminances of both the main display 21 and the sub display 13 separately and the operation is facilitated. In addition, in a case of wishing to increase or decrease the luminance of only the sub display 13, the luminance adjustment of only the sub display 13 is also possible. Accordingly, it is possible to appropriately adjust the luminances of the two displays by the simple operation.

Incidentally, the luminance adjustment is adjustment of the type that the luminance is adjusted by performing, for example, PWM (Pulse Width Modulation)-based control on the time taken for applying an electric current to a backlight of each display and is not adjustment of the type that the luminance value is ensured in accordance with an individual difference of the backlight and so forth. For example, “to adjust the display to the luminance of 400 nit” means “to adjust the display to a PWM value which is set in advance and with which a luminance which is equivalent to 400 nit would be obtained” and therefore the luminance does not necessarily become 400 nit accurately at the time of adjustment. However, here, for simplification of description, the luminance adjustment will be described by using the luminance value by expressing “adjusts something to the luminance of such and such nit” and so forth.

(Configuration of Electronic Apparatus 1)

Next, the configuration of the electronic apparatus 1 will be described in detail.

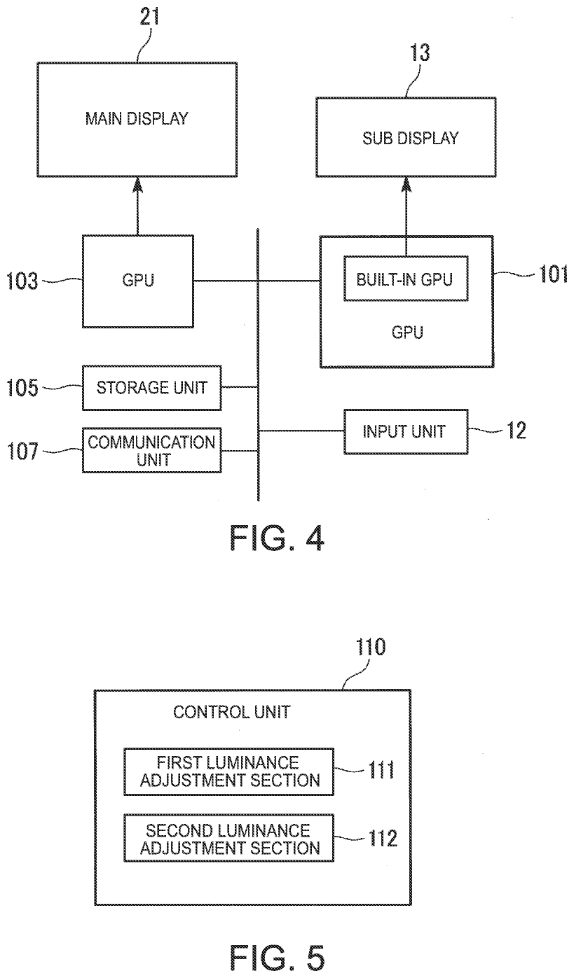

FIG. 4 is a schematic block diagram illustrating one configuration example of the electronic apparatus 1 according to the first embodiment. The electronic apparatus 1 is configured by including the input unit 12, the main display 21, the sub display 13, a CPU (Central Processing Unit) 101, a GPU (Graphic Processing Unit) 103, a storage unit 105, a communication unit 107 and so forth.

The input unit 12, the main display 21 and the sub display 13 correspond to the input unit 12, the main display 21 and the sub display 13 which are illustrated in FIG. 1 or FIG. 2 respectively. The input unit 12 accepts one user operation and outputs an operation signal which indicates the accepted user operation. Incidentally, an input device such as a mouse and so forth may be connected to the electronic apparatus 1 in addition to the keyboard, the touch pad, the touch sensor and so forth which serve as the input unit 12. In addition, either the main display 21 or the sub display 13 or both of them may be configured as a touch panel(s) which accept(s) operation input from the user.

The storage unit 105 is configured by including, for example, an HDD (Hard Disk Drive), an SSD (Solid State Device), an EEPROM (Electrically Erasable Programmable Read-Only Memory), a ROM (Read-Only Memory), a RAM (Random Access Memory) and so forth and stores various kinds of data, programs and so forth which are used in a case where the electronic apparatus 1 executes processing.

The communication unit 107 is connected with other apparatuses to be communicable over a wireless or wired communication network and transmits and receives the various kinds of data to and from the other apparatuses. For example, the communication unit 107 is configured by including a wired LAN (Local Area Network) interface which is based on the Bluetooth (a registered trademark) standard, the Ethernet (a registered trademark) standard and so forth, a wireless LAN interface which is based on the Wi-Fi (a registered trademark) standard and so forth.

The CPU 101 executes a program/programs which is/are stored in the storage unit 105 and thereby executes processing which is based on an OS (Operating System) and processing which is based on an application which operates on the OS. In addition, the CPU 101 is a processor into which a GPU is integrated and includes a built-in GPU 1011 (one example of a first GPU). That is, the built-in GPU 1011 is a built-in type GPU which is integrated into the CPU 101. The built-in GPU 1011 executes image processing for processing an image to be displayed on the sub display 13. For example, the built-in GPU 1011 generates an image signal by executing a drawing process for drawing image data and outputs the generated image signal to the sub display 13.

For example, the sub display 13 is a UHD (Ultra High Definition) display which is configured by 3,840×2,160 pixels. By way of example, the built-in GPU 1011 and the sub display 13 are connected with each other via a 4-lane 5.4 Gbps interface. In addition, also a control signal which is used to control the backlight of the sub display 13 is included in the interface between the built-in GPU 1011 and the sub display 13. For example, the built-in GPU 1011 controls the luminance of the sub display 13 by performing the PWM (Pulse Width Modulation)-based control on the time taken for applying the electric current to the backlight of the sub display 13.

The GPU 103 (one example of a second GPU) executes a process for drawing an image to be displayed on the main display 21. For example, the GPU 103 generates an image signal by executing a drawing process for drawing image data and outputs the generated image signal to the main display 21.

For example, the main display 21 is a UHD (Ultra High Definition) display which is configured by 3,840×2,160 pixels. By way of example, the GPU 103 and the main display are connected with each other via a 4-lane 5.4 Gbps interface. In addition, also a control signal which is used to control the backlight of the main display 21 is included in the interface between the GPU 103 and the main display 21. For example, the GPU 103 controls the luminance of the main display 21 by performing the PWM (Pulse Width Modulation)-based control on the time taken for applying the electric current to the backlight of the main display 21.

Incidentally, although in the above-mentioned explanation, one example that the interface between the built-in GPU 1011 and the sub display 13 and the interface between the GPU 103 and the main display 21 are configured by the 4-lane 5.4 Gbps interfaces of the same type is described, the respective interfaces may have mutually different specifications. For example, in a case where the sub display 13 is a display which is configured by 1,920×320 pixels, the built-in GPU 1011 and the sub display 13 may be connected together via a 1-lane 5.4 Gbps interface.

Next, a functional configuration relating to control of the luminance adjustment of the main display 21 and the sub display 13 of the electronic apparatus 1 will be described in detail.

FIG. 5 is a block diagram illustrating one example of the functional configuration relating to the luminance adjustment control according to the first embodiment. A control unit 110 which is illustrated in FIG. 5 is the functional configuration which is realized by executing the program(s) which is/are stored in the storage unit 105 by the CPU 101 which is illustrated in FIG. 4. The control unit 110 includes a first luminance adjustment section 111 and a second luminance adjustment section 112.

The first luminance adjustment section 111 performs the luminance adjustment of the main display 21 and the luminance adjustment of the sub display 13 in linkage with each other in accordance with an operation performed on the operation UI which accepts the operation for the luminance adjustment of the main display 21. For example, in a case of performing the luminance adjustment of the main display 21, the first luminance adjustment section 111 instructs to perform changing of the luminance of the main display 21 which accords with the operation concerned to the GPU 103 and instructs to perform changing of the luminance of the sub display 13 which accords with the operation concerned to the built-in GPU 1011. The GPU 103 performs the PWM-based control on the basis of the instruction from the first luminance adjustment section 111 and thereby changes (adjusts) the luminance of the main display 21. In addition, the built-in GPU 1011 performs the PWM-based control on the basis of the instruction from the first luminance adjustment section 111 and thereby changes (adjusts) the luminance of the sub display 13.

The second luminance adjustment section 112 performs only the luminance adjustment of the sub display 13 in accordance with the operation performed on the operation UI which accepts the operation for the luminance adjustment of the sub display 13. For example, in a case of performing the luminance adjustment of the sub display 13, the second luminance adjustment section 112 instructs to perform changing of the luminance of the sub display 13 which accords with the operation concerned to the built-in GPU 1011. The built-in GPU 1011 performs the PWM-based control on the basis of the instruction from the second luminance adjustment section 112 and thereby changes (adjusts) the luminance of the sub display 13.

Incidentally, the first luminance adjustment section 111 may perform the luminance adjustment of the main display 21 and the luminance adjustment of the sub display 13 in linkage with each other so as to maintain a relation (for example, a ratio, a difference and so forth) between the luminance of the main display 21 and the luminance of the sub display 13.

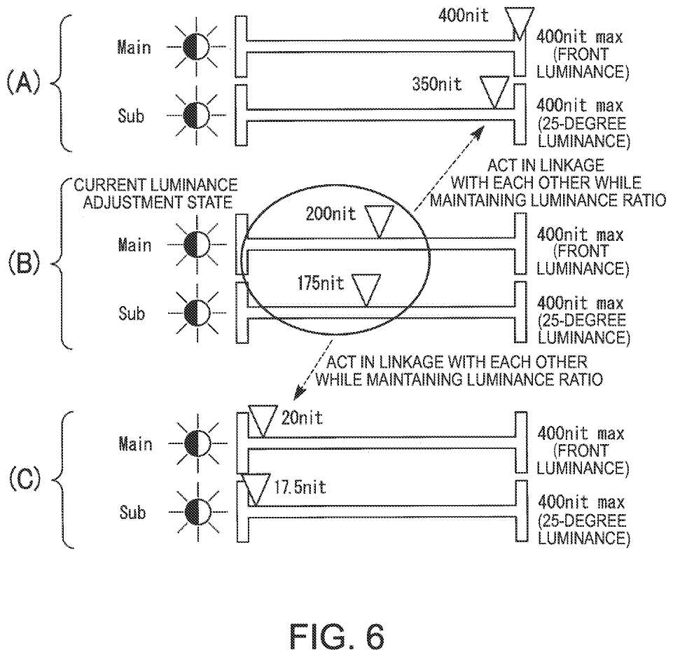

One example of linkage between the luminance adjustment of the main display 21 and the luminance adjustment of the sub display 13 will be described with reference to FIG. 6.

FIG. 6 is a diagram illustrating one example of the luminance adjustment according to the first embodiment. In FIG. 6, FIG. 6(A) illustrates one example of the luminance adjustment in a case of performing the operation on the operation UI which is used for the luminance adjustment which is the same as the operation UI in FIG. 3A and which accepts the operation for the luminance adjustment of the main display 21. FIG. 6(B) illustrates one example of a current luminance adjustment state and, it is supposed that the luminance of the main display 21 is 200 nit and the luminance of the sub display 13 is 175 nit. When moving (sliding) the inverted-triangle mark which indicates the current adjustment value of the main display 21 from this state in the left-right direction, also the inverted-triangle mark which indicates the current luminance value of the sub display 13 is moved in linkage with movement of the inverted-triangle mark for the main display 21 and the luminance of the main display 21 and the luminance of the sub display 13 are changed in linkage with each other while maintaining the ratio between the both. As illustrated in FIG. 6(A), in a case where the inverted-triangle mark which indicates the current adjustment value of the main display 21 is moved rightward and thereby the luminance of the main display 21 is increased to 400 nit which is twice as high as 200 nit, also the luminance of the sub display 13 is increased to 350 nit which is twice as high as 175 nit. In addition, as illustrated in FIG. 6(C), in a case where the inverted-triangle mark which indicates the current adjustment value of the main display 21 is moved leftward and thereby the luminance of the main display 21 is decreased to 20 nit which is one-tenth of 200 nit, also the luminance of the sub display 13 is decreased to 17.5 nit which is one-tenth of 175 nit.

Incidentally, in a case of moving the inverted-triangle mark which indicates the current adjustment value of the main display 21 further leftward, both the luminance of the main display 21 and the luminance of the sub display 13 are decreased limitlessly and therefore the both luminances may be decreased to zeros at the time point of moving the inverted-triangle marks to the left end.

Next, operations of luminance adjustment processing in the electronic apparatus 1 will be described.

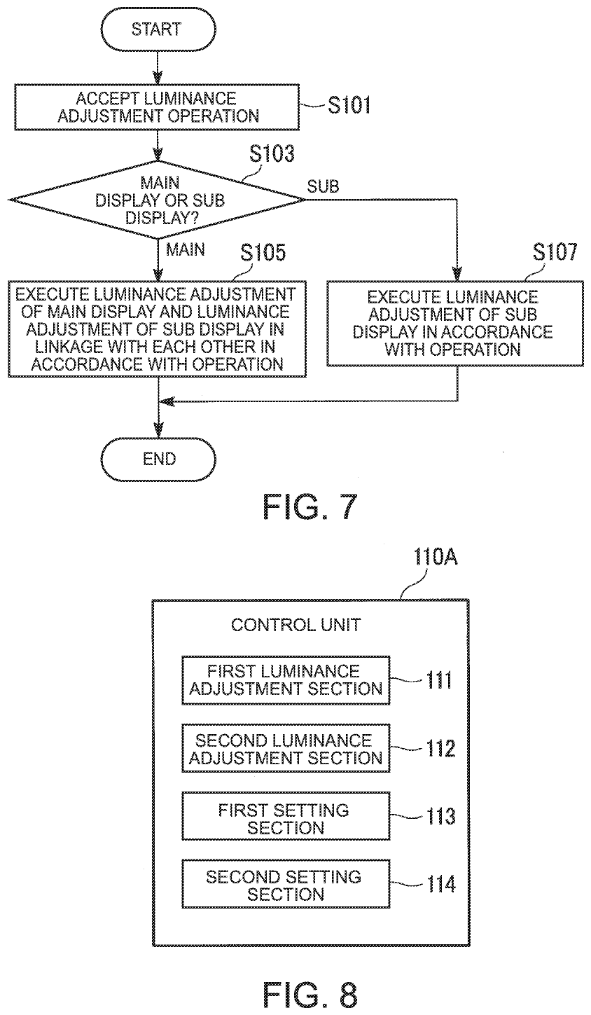

FIG. 7 is a flowchart illustrating one example of the luminance adjustment processing according to the first embodiment.

(Step S101): The control unit 110 accepts the operation for the luminance adjustment on the basis of the operation signal which is output from the input unit 12 and then proceeds to a process in step S103.

(Step S103): The control unit 110 decides whether the operation which is accepted in step S101 is the operation performed on the operation UI which accepts the operation for the luminance adjustment of the main display 21 or the operation performed on the operation UI which accepts the operation for the luminance adjustment of the sub display 13. Then, the control unit 110 proceeds to a process in step S105 or a process in step S107 in accordance with a result of decision.

(Step S105): In a case where it is decided that the operation which is accepted in step S101 is the operation performed on the operation UI which accepts the operation for the luminance adjustment of the main display 21 in step S103, the control unit 110 performs the luminance adjustment of the main display 21 and the luminance adjustment of the sub display 13 in linkage with each other in accordance with the operation concerned.

(Step S107): In a case where it is decided that the operation which is accepted in step S101 is the operation performed on the operation UI which accepts the operation for the luminance adjustment of the sub display 13 in step S103, the control unit 110 performs only the luminance adjustment of the sub display 13 in accordance with the operation concerned.

As described above, the electronic apparatus 1 according to the first embodiment performs the luminance adjustment of the main display 21 and the luminance adjustment of the sub display 13 (one example of a second display unit) in linkage with each other in accordance with the operation (one example of a first operation) performed on the operation UI which accepts the operation for the luminance adjustment of the main display 21 (one example of a first display unit) in linkage with each other. In addition, the electronic apparatus 1 performs only the luminance adjustment of the sub display 13 in accordance with the operation (one example of a second operation) performed on the operation UI which accepts the operation for the luminance adjustment of the sub display 13.

Thereby, in a case where the user adjusts the luminance of the main display 21, the electronic apparatus 1 adjusts also the luminance of the sub display 13 in linkage with the luminance adjustment of the main display 21. Therefore, for example, in a case of wishing to increase or decrease the luminances of the both displays, it is not necessary to separately adjust the luminances of the respective displays and therefore the operation is facilitated. In addition, in a case of wishing to increase or decrease only the luminance of the sub display 13, it is also possible for the electronic apparatus 1 to adjust the luminance of only the sub display 13. Accordingly, it becomes possible to appropriately adjust the luminances of the two displays by the simple operation.

For example, the electronic apparatus 1 performs the luminance adjustment of the main display 21 and the luminance adjustment of the sub display 13 in linkage with each other in accordance with the operation (one example of the first operation) performed on the operation UI which accepts the operation for the luminance adjustment of the main display 21 in such a manner that the relation (for example, the ratio, the difference and so forth) between the luminance of the main display 21 and the luminance of the sub display 13 is maintained.

Thereby, in a case where the luminance of the main display 21 is changed by the user, the electronic apparatus 1 changes also the luminance of the sub display 13 in linkage with changing of the luminance of the main display 21 by a luminance change amount which is similar to a luminance change amount of the main display 21 and therefore it becomes possible to appropriately adjust the luminances of the two displays in accordance with the user operation.

In addition, the sub display 13 is an auxiliary display which is smaller in display screen area than the main display 21. Therefore, in the electronic apparatus 1, in a case where the user changes the luminance of the main display 21 that the user visually confirms mainly while the electronic apparatus 1 is being used depending on the environment, also the luminance of the sub display 13 is changed in linkage with changing of the luminance of the main display 21 and therefore it is not necessary to adjust the luminances of the both displays depending on the environment and the operation is not troublesome.

In addition, the electronic apparatus 1 includes the first main body 10 on which the input unit 12 into which the user operation is input is installed and the second main body 20 which is coupled to the first main body 10 to be rotationally movable relatively. The main display 21 is installed on the second main body 20. On the other hand, the sub display 13 is installed on the face side of the first main body 10 on which the input unit 12 is installed. Then, the sub display 13 is set higher than the main display 21 in maximum value of the front luminance.

Thereby, even in a case where the main display 21 and the sub display 13 are arranged on different faces, the electronic apparatus 1 makes it possible to equalize the luminances of the both displays in the user's eye gaze direction and thereby makes it easier to see the both displays.

### Second Embodiment

Next, the second embodiment of the present invention will be described.

In the second embodiment, one example that it is possible to set in advance the both ends of the luminance adjustment range, that is, an adjustment value which becomes a maximum luminance and an adjustment value which becomes a minimum luminance will be described.

FIG. 8 is a block diagram illustrating one example of a functional configuration relating to luminance adjustment control according to the second embodiment. A control unit 110A which is illustrated in FIG. 8 is the functional configuration that the CPU 101 which is illustrated in FIG. 4 realizes by executing the program(s) which is/are stored in the storage unit 105 and is different from the control unit 110 which is illustrated in FIG. 5 in the point that the control unit 110A includes a first setting section 113 and a second setting section 114. Each of the first setting section 113 and the second setting section 114 sets in advance an adjustment value which becomes a maximum luminance of each display and an adjustment value which becomes a minimum luminance of each display on the basis of a user operation. These adjustment values may be settable either in setting items that the OS has or in an application which operates on the OS.

The first setting section 113 sets a first adjustment value which becomes a maximum luminance and a second adjustment value which becomes a minimum luminance in the luminance adjustment range of the main display 21. For example, the first setting section 113 sets the first adjustment value (for example, 400 nit) which becomes the maximum luminance and the second adjustment value (for example, 0 nit) which becomes the minimum luminance on the basis of the user operation concerned. Incidentally, either the first adjustment value or the second adjustment may be made settable on the basis of the user operation.

The second setting section 114 sets a third adjustment value which becomes a maximum luminance and a fourth adjustment value which becomes a minimum luminance in a luminance adjustment range of the sub display 13. For example, the second setting section 114 sets the third adjustment value (for example, 400 nit) which becomes the maximum luminance and the fourth adjustment value (for example, 5 nit) which becomes the minimum luminance in the luminance adjustment range of the sub display 13 on the basis of the user operation concerned. Incidentally, either the third adjustment value or the fourth adjustment may be made settable on the basis of the user operation.

Then, the first luminance adjustment section 111 adjusts the luminance of the main display 21 so as to be changed between the first adjustment value (for example, 400 nit) and the second adjustment value (for example, 0 nit) and adjusts the luminance of the sub display 13 so as to be changed between the third adjustment value (for example, 400 nit) and the fourth adjustment value (for example 5 nit) in accordance with the user operation which is performed on the operation UI of the main display 21. In addition, the second luminance adjustment section 112 adjusts the luminance of the sub display 13 so as to be changed between the third adjustment value (for example, 400 nit) and the fourth adjustment value (for example, 5 nit) in accordance with the operation which is performed on the operation UI of the sub display 13.

In addition, the first setting section 113 may set a fifth adjustment value which becomes a predetermined luminance between the first adjustment value which becomes a maximum luminance and the second adjustment value which becomes a minimum luminance in the luminance adjustment range of the main display 21 on the basis of the user operation concerned. Likewise, the second setting section 114 may set a sixth adjustment value which becomes a predetermined luminance between the third adjustment value which becomes a maximum luminance and the fourth adjustment value which becomes a minimum luminance in the luminance adjustment range of the sub display 13 on the basis of the user operation concerned. For example, in a case of adjusting the luminance of the main display 21 between the first adjustment value and the second adjustment value in accordance with the operation which is performed on the operation UI of the main display 21, the first luminance adjustment section 111 adjusts the luminance of the main display 21 so as to be changed by passing the fifth adjustment value and, in a case of adjusting the luminance of the sub display 13 between the third adjustment value and the fourth adjustment value, the first luminance adjustment section 111 adjusts the luminance value of the sub display 13 so as to be changed by passing the sixth adjustment value. In addition, in a case of adjusting the luminance of the sub display 13 between the third adjustment value and the fourth adjustment value in accordance with the operation which is performed on the operation UI of the sub display 13, the second luminance adjustment section 112 adjusts the luminance value of the sub display 13 so as to be changed by passing the sixth adjustment value.

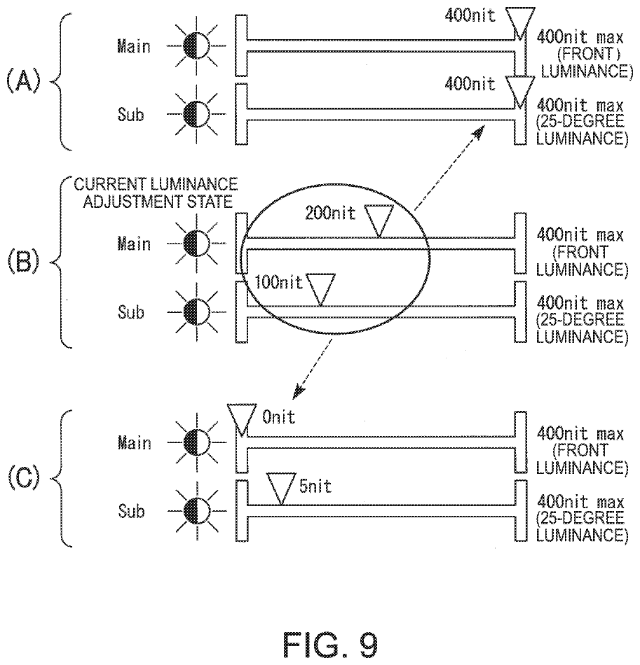

FIG. 9 is a diagram illustrating one example of the luminance adjustment according to the second embodiment. FIG. 9 illustrates one example of the luminance adjustment in a case of performing the operation on the operation UI for the luminance adjustment which is the same as the operation UI illustrated in FIG. 6 and which accepts the operation for the luminance adjustment of the main display 21. FIG. 9(A) illustrates one example of a state where the luminances of the main display 21 and the sub display 13 are adjusted to the maximum luminances respectively, that is, the luminance of the main display 21 is set to 400 nit (the first adjustment value) and the luminance of the sub display 13 is set to 400 nit (the third adjustment value). This setting is made on the assumption of using the electronic apparatus 1 in a bright environment. Since the sub display 13 turns upward and thus it becomes difficult to see the sub display 13 under a natural light source, setting is made so as to increase the luminance of the sub display 13 as much as possible.

On the other hand, FIG. 9(C) illustrates one example of a state where the luminances of the main display 21 and the sub display 13 are adjusted to the minimum luminances, that is, the luminance of the main display 21 is set to 0 nit (the second adjustment value) and the luminance of the sub display 13 is set to 5 nit (the fourth adjustment value). This setting is made on the assumption that while the user is sleeping at night, the main display 21 is turned off and the sub display 13 is used as an information bar by setting the sub display 13 to a dim state.

FIG. 9(B) illustrates one example of a current luminance adjusted state and, in this example, it is supposed that the luminance of the main display 21 is adjusted to 200 nit and the luminance of the sub display 13 is adjusted to 100 nit. In a case of moving (sliding) the inverted-triangle mark which indicates the current adjustment value of the main display 21 in the left-right direction from this state, also the inverted-triangle mark which indicates the current adjustment value of the sub display 13 is moved in linkage with movement of the inverted-triangle mark of the main display 21, that is, is moved between the maximum value and the minimum value which are set in linkage with movement of the inverted-triangle mark of the main display 21.

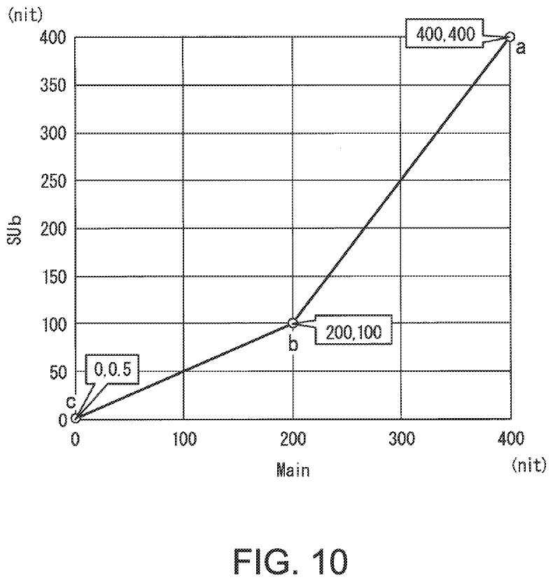

FIG. 10 is a diagram illustrating one example of a change in luminance when adjusted which is illustrated in FIG. 9 in the form of a graph. The horizontal axis indicates the luminance of the main display 21 and the vertical axis indicates the luminance of the sub display 13. A point “a” indicates the adjustment values (the first adjustment value and the third adjustment value) of the maximum luminance, a point “b” indicates the current luminance adjustment values (the fifth adjustment value and the sixth adjustment value) and a point “c” indicates the adjustment values (the second adjustment value and the fourth adjustment value) of the minimum luminance respectively.

In a case of moving the inverted-triangle mark which indicates the current adjustment value of the main display 21 rightward from the current luminance adjustment state (from the state in FIG. 9(B) to the state in FIG. 9(A), the luminances are changed from the luminance adjustment values (200 nit and 100 nit) at the point “b” to the luminance adjustment values (400 nit and 400 nit) at the point “a” along a line connecting the point “b” with the point “a”. On the other hand, in a case of moving the inverted-triangle mark which indicates the current adjustment value of the main display 21 leftward from the current luminance adjustment state (from the state in FIG. 9(B) to the state in FIG. 9(C), the luminances are changed from the luminance adjustment values (200 nit and 100 nit) at the point “b” to the luminance adjustment values (0 nit and 5 nit) at the point “c” along a line connecting the point “b” with the point “c”. The luminance of the main display 21 and the luminance of the sub display 13 are changed from the values at the point “a” to the values at the point “c” (or from the values at the point “c” to the values at the point “a”) by passing the point “b” in this way.

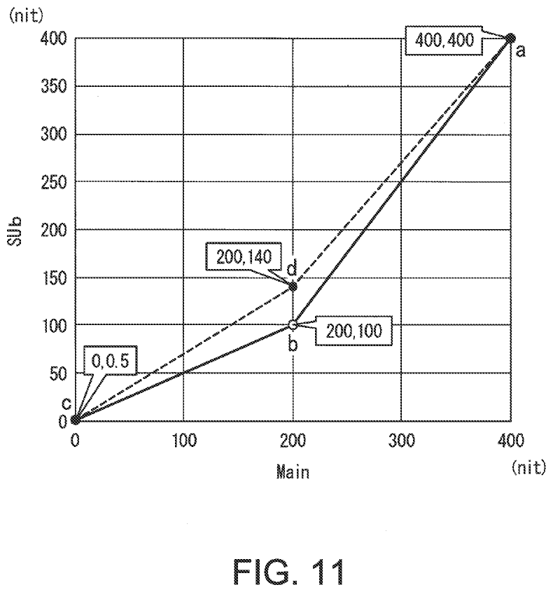

In addition, in a case where in the current luminance adjustment values (the fifth adjustment value and the sixth adjustment value), the current adjustment value only on the sub display 13 side is changed in accordance with the user operation which is performed on the operation UI of the sub display 13, setting of the current luminance adjustment values is changed. FIG. 11 is a diagram illustrating one example of a change in luminance when adjusted in a case of changing the current luminance adjustment values in the form of a graph. For example, in a case where the current luminance adjustment value of the sub display 13 is changed from 100 nit to 140 nit in accordance with the user operation which is performed on the operation UI of the sub display 13, setting of the current luminance adjustment values is changed from the setting at the point “b” (200 nit and 100 nit) to setting at a point “d” (200 nit and 140 nit) as illustrated in FIG. 11.

Then, in a case of moving the inverted-triangle mark which indicates the current adjustment value of the main display 21 rightward from the current luminance adjustment state (from the state in FIG. 9(B) to the state in FIG. 9(A)), the luminances are changed from the luminance adjustment values (200 nit and 140 nit) at the point “d” to the luminance adjustment values (400 nit and 400 nit) at the point “a” along a line connecting the point “d” with the point “a”. On the other hand, in a case of moving the inverted-triangle mark which indicates the current adjustment value of the main display 21 leftward from the current luminance adjustment state (from the state in FIG. 9(B) to the state in FIG. 9(C)), the luminances are changed from the luminance adjustment values (200 nit and 140 nit) at the point “d” to the luminance adjustment values (0 nit and 5 nit) at the point “c” along a line connecting the point “d” with the point “c”. In a case where only the current adjustment value of only the sub display 13 side is changed in this way, a way of changing the luminance of the main display 21 and the luminance of the sub display 13 is altered from a way of changing the luminances via the point “b” to a way of changing the luminances via the point “d” as illustrated in FIG. 11.

As described above, the electronic apparatus 1 according to the second embodiment sets at least one of the first adjustment value (for example, see the point “a” in FIG. 10 and FIG. 11) which becomes the maximum luminance and the second adjustment value (for example, see the point “c” in FIG. 10 and FIG. 11) which becomes the minimum luminance in the luminance adjustment range of the main display 21 (one example of the first display unit) on the basis of the user operation (see FIG. 9(A), FIG. 9(C), FIG. 10 and FIG. 11). In addition, the electronic apparatus 1 sets at least one of the third adjustment value (for example, see the point “a” in FIG. 10 and FIG. 11) which becomes the maximum luminance and the fourth adjustment value (for example, see the point “c” in FIG. 10 and FIG. 11) which becomes the minimum luminance in the luminance adjustment range of the sub display 13 (one example of the second display unit) on the basis of the user operation.

Then, the electronic apparatus 1 adjusts the luminance of the main display 21 so as to be changed between the first adjustment value and the second adjustment value and adjusts the luminance of the sub display 13 so as to be changed between the third adjustment value and the fourth adjustment value in accordance with the operation (one example of the first operation) which is performed on the operation UI of the main display 21. In addition, the electronic apparatus 1 adjusts the luminance of the sub display 13 so as to be changed between the third adjustment value and the fourth adjustment value in accordance with the operation (one example of the second operation) which is performed on the operation UI of the sub display 13.

Thereby, since it becomes possible for the electronic apparatus 1 to set in advance the maximum value and the minimum value which are used in the luminance adjustment of each of the main display 21 and the sub display 13, it becomes possible for the user to appropriately adjust the luminances of the two displays by the simple operation in accordance with an environment that the user uses the electronic apparatus 1.

In addition, the electronic apparatus 1 may set the fifth adjustment value (for example, the value at the point “d” in FIG. 10 and FIG. 11) which becomes the predetermined luminance between the first adjustment value which becomes the maximum luminance and the second adjustment value which becomes the minimum luminance in the luminance adjustment range of the main display 21 (one example of the first display unit) on the basis of the user operation. In addition, the electronic apparatus 1 may also set the sixth adjustment value (for example, the value at the point “d” in FIG. 10 and FIG. 11) which becomes the predetermined luminance between the third adjustment value which becomes to the maximum luminance and the fourth adjustment value which becomes the minimum luminance in the luminance adjustment range of the sub display 13 (one example of the second display unit) on the basis of the user operation. Then, the electronic apparatus 1 may adjust the luminance of the main display 21 so as to change the luminance by passing the fifth adjustment value in a case of adjusting the luminance of the main display 21 between the first adjustment value and the second adjustment value and may adjust the luminance of the sub display 13 so as to change the luminance by passing the sixth adjustment value in a case of adjusting the luminance of the sub display 13 between the third adjustment value and the fourth adjustment value in accordance with the operation (one example of the first operation) which is performed on the operation UI of the main display 21. In addition, the electronic apparatus 1 may adjust the luminance of the sub display 13 so as to change the luminance by passing the sixth adjustment value in a case of adjusting the luminance of the sub display 13 between the third adjustment value and the fourth adjustment value in accordance with the operation (one example of the second operation) which is performed on the operation UI of the sub display 13.

Incidentally, the fifth adjustment value and the sixth adjustment value may be set by the operation which is performed on the operation UI of the sub display 13, may be made settable in the setting items that the OS has and/or may be made settable in the application which operates on the OS.

Thereby, since it becomes possible for the electronic apparatus 1 to set also an intermediate luminance in addition to setting of the maximum luminance and the minimum luminance to be used in the luminance adjustment of each of the main display 21 and the sub display 13, it becomes possible to appropriately adjust the luminances of the two displays by the simple operation in accordance with the environment that the user uses the electronic apparatus 1.

Although the embodiments of the present invention have been described in detail with reference to the drawings as above, specific configurations are not limited to the above-described embodiments and also designs and so forth which are made in a range not deviating from the gist of the present invention are included. It is possible to optionally combine the respective configurations which are described in the respective embodiments with one another/each other.

Although in the above-described embodiments, the example that the sub display 13 is configured to be rotationally movable relative to the first main body 10 via the second hinge H2 is described, the sub display 13 may be configured so as not to rotationally move (configured to be fixed to the first main body 10). For example, the main display 21 and the sub display 13 may be arranged side by side on the same plane (for example, on the face of the second main body 20 on which the main display 21 is installed).

In addition, although in the above-described embodiments, the example that the two displays (the display units), that is, the main display 21 and the sub display 13 are installed on the electronic apparatus 1 is described, the two displays (the display units) may be configured to be connected to the electronic apparatus 1 as external devices.

In addition, although in the above-described embodiments, the configuration example that the two displays are controlled by using the built-in GPU 1011 which is built in the CPU 101 and the GPU 103 which is installed separately from the CPU 101 is described, the configuration is not limited to this example. For example, such a configuration that two GPUs which are not built in the CPU 101 are prepared and the two displays are controlled by using the two GPUs may be also made. In addition, such a configuration that the CPU 101 builds therein two GPUs and the two displays are controlled by using the two built-in GPUs may be also made.

In addition, although in the above-described embodiments, the configuration that the luminance adjustment of the two displays (the display units) is controlled is described, such a configuration that the luminance adjustment of three or more displays (the display units) is controlled may be also made. For example, in an electronic apparatus which has one main display and two sub displays, luminance adjustment of the main display and luminance adjustment of the two sub displays may be performed in linkage with each other/one another in accordance with the operation which is performed on the operation UI for the luminance adjustment of the main display. In addition, only the luminance adjustment of one of the sub displays which corresponds to the operation UI which is operated may be performed in accordance with the operation which is performed on the operation UI for the luminance adjustment of each of the two sub displays.

In addition, in the above-described embodiments, an EC (Embedded Controller) 200 which operates independently of a system processing unit 300 may be any of processing units such as a sensor hub, a sensor chip and so forth and a processing unit other than the EC 200 may execute the above-described processing in place of the EC 200. In general, the total power consumption of the processing units such as the EC 200 and so forth and a proximity sensor 130 is greatly less the than the power consumption of the system processing unit 300.

Incidentally, the above-mentioned electronic apparatus 1 has a computer system therein. Then, processing in each configuration that the above-mentioned electronic apparatus 1 includes may be performed by recording a program which is used for realization of each configuration that the above-mentioned electronic apparatus 1 includes onto a computer-readable recording medium, reading the program which is recorded onto the recoding medium into the computer system and then executing the program. Here, “reading the program which is recorded onto the recording medium into the computer system and then executing the program” implies installation of the program into the computer system. Here, “the computer system” includes software such as the OS and so forth and hardware such as peripherals and so forth. In addition, “the computer system” may also include a plurality of computer devices which are connected with each other/one another over a network which includes communication lines such as the Internet, a WAN (Wide Area Network), a LAN (Local Area Network), a private line and so forth. In addition, “the computer-readable recording medium” means portable media such as a flexible disk, a magneto-optical disk, a ROM, a CD (Compact Disk)-ROM and so forth, storages such as a hard disk and so forth which are built in the computer system and so forth. The recording medium which records the program in this way may be a non-transitory recording medium such as the CD-ROM and so forth.

In addition, the recording medium also includes internally and externally installed recording media which are accessible from a distribution server for distribution of the program concerned. Incidentally, a configuration that a program is divided into a plurality of parts, and the divided parts of the program are downloaded at mutually different timings and thereafter are combined together by respective configurations that the electronic apparatus 1 has may be made and in this case the distribution servers which distribute the divided parts of the program respectively may be different from one another. Further, “the computer-readable recording medium” also includes media of the type of holding a program for a definite period of time such as the server which operates in a case where the program is transmitted to the server over the network and a volatile memory (a RAM) which is built in the computer system which serves as a client. In addition, the above-described program may be also a program which is adapted to realize some of the above-described functions. Further, the program may be also a program which is able to realize the above-described functions by being combined with a program which is already recorded on the computer system, that is, a so-called a differential file (a differential program).

In addition, some or all of the respective functions that the electronic apparatus 1 according to the above-described embodiments includes may be realized as an integrated circuit such as an LSI (Large Scale Integration) and so forth. The respective functions may be individually processed and some or all of the functions may be integrated with one another and then processed. In addition, an approach for circuit integration may be realized by a private circuit or a general-purpose processor, not limited to the LSI. In addition, in appearance of a technique for realizing circuit integration which would take the place of the LSI owing to progress of the semiconductor technology, an integrated circuit which is realized by the technique concerned may be used.

Incidentally, the electronic apparatus 1 may be a desk-top type PC, a tablet-type PC, a cellphone, a smartphone, a gaming machine and so forth as long as the electronic apparatus 1 is of the type of displaying images on the plurality of displays. In addition, the electronic apparatus 1 is also applicable to various electronic apparatuses such as household electric appliances (a TV set, a refrigerator and so forth) not limited to information processing apparatuses such as the PC, the smartphone and so forth as long as the electronic apparatus 1 is of the type of displaying the images on the plurality of displays.

1. An electronic apparatus comprising:
a first luminance adjustment section which performs luminance adjustment of a first display unit and luminance adjustment of a second display unit, in conjunction with each other, in accordance with a first operation; and
a second luminance adjustment section which performs only the luminance adjustment of the second display unit in accordance with a second operation.

2. The electronic apparatus according to claim 1, wherein
the first luminance adjustment section:
performs the luminance adjustment of the first display unit and the luminance adjustment of the second display unit, in conjunction with each other, in accordance with the first operation, in such a manner that a relation between a luminance of the first display unit and a luminance of the second display unit is maintained.

3. The electronic apparatus according to claim 1, further comprising:
a first setting section which sets at least one of a first adjustment value which becomes a maximum luminance and a second adjustment value which becomes a minimum luminance in a range of the luminance adjustment of the first display unit on the basis of a user operation; and
a second setting section which sets at least one of a third adjustment value which becomes a maximum luminance and a fourth adjustment value which becomes a minimum luminance in a range of the luminance adjustment of the second display unit on the basis of a user operation, wherein
the first luminance adjustment section:
adjusts the luminance of the first display unit to between the first adjustment value and the second adjustment value, and adjusts the luminance of the second display unit to between the third adjustment value and the fourth adjustment value, and
the second luminance adjustment section:
adjusts the luminance of the second display unit to between the third adjustment value and the fourth adjustment value.

4. The electronic apparatus according to claim 3, wherein
the first setting section:
sets a fifth adjustment value which becomes a predetermined luminance between the first adjustment value and the second adjustment value on the basis of a user operation,
the second setting section:
sets a sixth adjustment value which becomes a predetermined luminance between the third adjustment value and the fourth adjustment value on the basis of a user operation,
the first luminance adjustment section:
adjusts the luminance of the first display unit to pass the fifth adjustment value in a case of adjusting the luminance of the first display unit between the first adjustment value and the second adjustment value, and adjusts the luminance of the second display unit to pass the sixth adjustment value in a case of adjusting the luminance of the second display unit between the third adjustment value and the fourth adjustment value, and
the second luminance adjustment section:
adjusts the luminance of the second display unit to pass the sixth adjustment value in a case of adjusting the luminance of the second display unit between the third adjustment value and the fourth adjustment value.

5. The electronic apparatus according to claim 1, wherein
the second display unit is smaller than the first display unit in area of a display screen.

6. The electronic apparatus according to claim 1, further comprising:
a first main body which installs thereon an input unit into which a user operation is input; and
a second main body which is coupled to the first main body to be rotationally movable relative to the first main body, wherein
the first display unit is installed on the second main body,
the second display unit is installed on a face side of the first main body which is the same as the face side on which the input unit is installed, and
the second display unit is set higher than the first display unit in maximum value of a front luminance.

7. A controlling method for an electronic apparatus comprising the steps of:
performing luminance adjustment of a first display unit and luminance adjustment of a second display unit in conjunction with each other, in accordance with a first operation by using a first luminance adjustment section; and
performing only the luminance adjustment of the second display unit in accordance with a second operation by using a second luminance adjustment section.

8. An electronic apparatus comprising:
a first display unit;
a second display unit;
a first GPU (Graphic Processing unit) which controls a luminance of the first display unit; and
a second GPU which controls a luminance of the second display unit.

9. The electronic apparatus according to claim 8, wherein
the second GPU:
controls the luminance of the second display unit to become higher than the luminance of the first display unit in a state where the first display unit and the second display unit are arranged facing different directions.

10. The electronic apparatus according to claim 9, wherein
a ratio of the luminance of the first display unit to the luminance of the second display unit is defined in accordance with an angle between a direction that the first display unit is oriented and a direction that the second display unit is oriented.

11. The electronic apparatus according to claim 8, wherein
the first GPU is a CPU built-in type GPU which is integrated into a CPU (Central Processing Unit).
